(19) United States
(12) Patent Application Publication
(10) Pub. No.: US 2003/0067224 A1
(43) Pub. Date: Apr. 10, 2003

(54) AC adapter for computer

(76) Inventor: Chin-Chung Tai, Tao-Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/946,353

(22) Filed: Sep. 6, 2001

(51) Int. Cl. H01H 35/00

(52) U.S. Cl. 307/117

(57) ABSTRACT

An AC adapter for computer is constructed to include an AC power input socket adapted to obtain external AC power supply, a plurality of AC power output sockets adapted to provide AC power supply to computer peripheral apparatus being connected thereto, and an electronic device formed of a relay and adapted to switch on/off the AC power output sockets subject to the working status of the motherboard of the computer in which the AC adapter is installed.

### BACKGROUND OF THE INVENTION

The present invention relates to an AC adapter for computer and, more particularly, to such an AC adapter for computer, which comprises a plurality of AC power output sockets for output of AC power supply to computer peripheral apparatus connected thereto, and an electronic device that switches on/off the AC power output sockets subject to the on/off status of the mainframe of the computer.

FIG. 1 shows an AC adapter 7 for computer according to the prior art. This structure of AC adapter 7 comprises a housing 71, the housing 71 having a back panel 72 and an exhaust port 74 in the back panel 72, an exhaust fan 75 installed in the housing 71 in front of the exhaust port 74, and two electric connectors 73 including one AC power input socket and one AC power output socket. Because this structure of AC adapter 7 has only one AC power output socket for providing power supply to the monitor of the computer, other computer peripheral apparatus such as modem, printer, scanner, etc. cannot obtain power supply from the AC adapter 7. Therefore, other computer peripheral apparatus must be respectively connected to external electric outlets to obtain power supply. When turning off the computer, the user must turn off the connected computer peripheral apparatus separately. Because the computer peripheral apparatus must be separately turned off, the user may forget to turn off the computer peripheral apparatus after working, thereby causing a waste of power supply.

### SUMMARY OF THE INVENTION

According to one aspect of the present invention, the AC adapter for computer comprises an AC power input socket adapted to obtain external AC power supply, a plurality of AC power output sockets adapted to provide AC power supply to computer peripheral apparatus being connected thereto. According to another aspect of the present invention, the AC adapter further comprises an electronic device formed of a relay or equivalent electronic circuit means and adapted to switch on/off the AC power output sockets subject to the on/off status of the motherboard of the computer in which the AC adapter is installed.

### BRIEF DESCRIPTION OF THE DRAWINGS

FIG. 1 is a perspective view of an AC adapter for computer constructed according to the prior art.

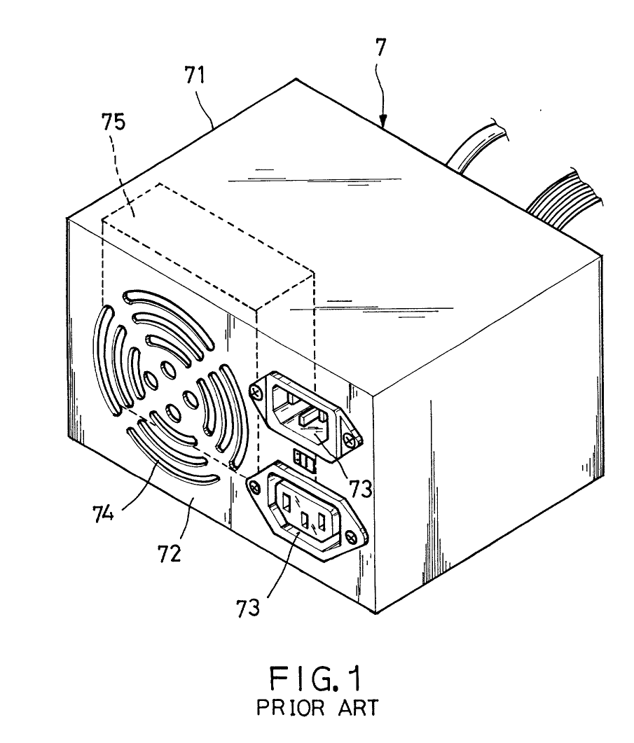

FIG. 2 is a perspective view of an AC adapter for computer constructed according to the present invention.

FIG. 3 is a circuit block diagram of the present invention.

FIG. 4 illustrates the installation of the AC adapter in the mainframe of the computer according to the present invention.

FIG. 5 is a schematic drawing showing the synchronous on/off switching circuit arrangement of the AC power output sockets and the motherboard according to the present invention.

### DETAILED DESCRIPTION OF THE PREFERRED EMBODIMENT

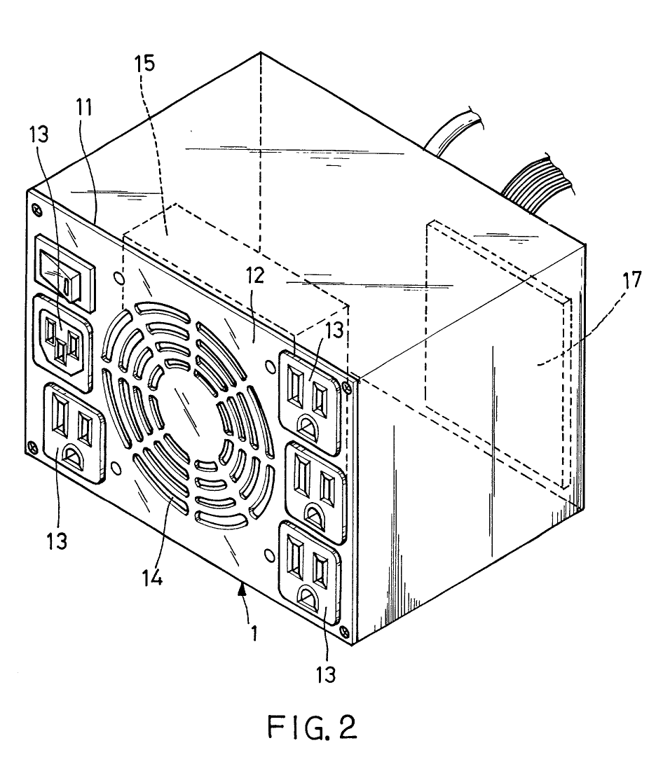

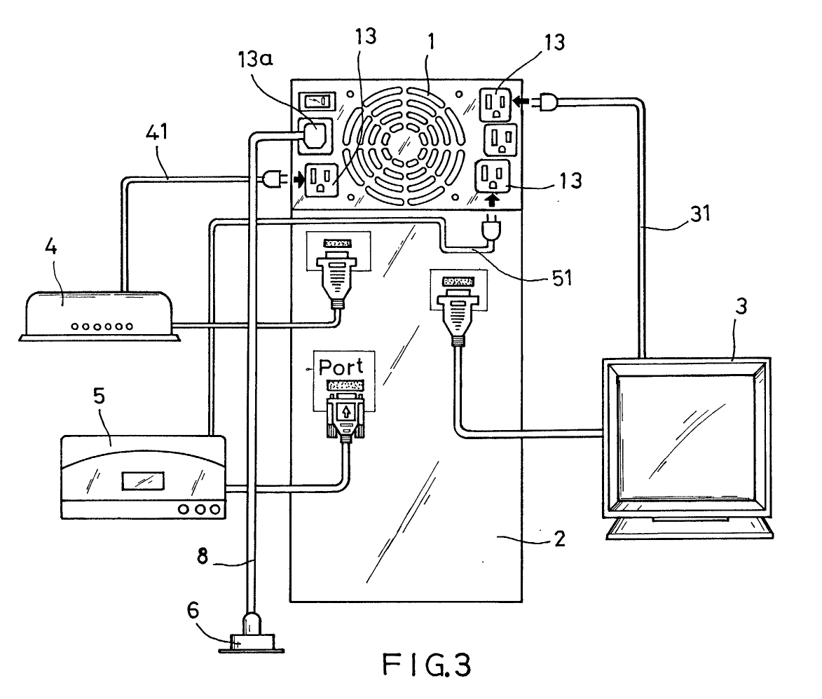

Referring to FIGS. 2 and 3, an AC adapter 1 is shown comprising a housing 1. The housing 1 has an exhaust port 14 in the back panel 12 thereof. An exhaust fan 15 is mounted inside the housing 1 in front of the exhaust port 14. A plurality of electric connectors including one AC power input socket 13a and a number of AC power output sockets 13 are mounted in the back panel 12 of the housing 1. As shown in FIG. 3, a main power cable 8 is connected to the AC power input socket 13a, having an electric plug 6 connected to city power supply. The power output sockets 13 receive the power cables of computer peripheral apparatus, for example, the power cable 31 of a monitor 3, the power cable 41 of a modem 4, and the power cable 51 of a printer 5. Therefore, city power supply is transmitted through the main power cable 8 to the AC power input socket 13a, and then distributed from the AC power input socket 13a to the AC power output sockets 13 and the computer peripheral apparatus 3;4;5.

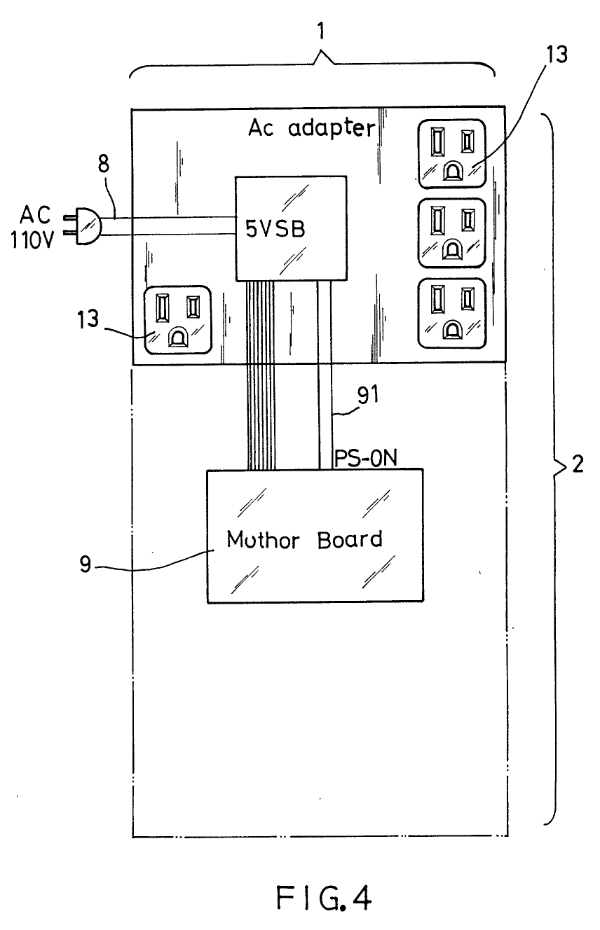

Referring to FIG. 4, when the main power cable 8 obtains AC power supply for the AC adapter 1, AC power supply is simultaneously transmitted to the motherboard 9 of the mainframe 2 of the computer in which the AC adapter 1 is installed as well as the power output sockets 13.

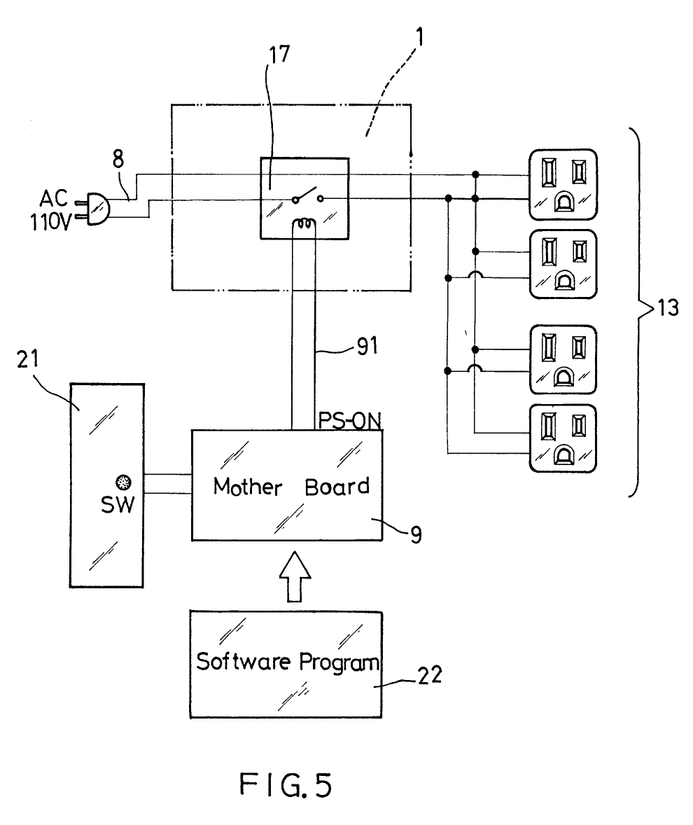

Referring to FIG. 5, an electronic device 17 is installed in the AC adapter 1. The electronic device 17 can be a relay or equivalent electronic circuit means. By means of the on/off switch SW that switches on/off the motherboard 21 of the computer, or the operating software program 22 that controls the operation of the motherboard 9, the electronic device 17 directly controls on/off of the AC power output sockets 13 of the AC adapter 1 subject to the on/off status of the motherboard 9. When the PS-ON signal line 91 is at high potential, the relay 17 is turned from the close-circuit status to the open-circuit status, and the AC adapter 1 is off. On the contrary, when the PS-ON signal line 91 is at low potential, the relay 17 is turned from the open-circuit status to the close-circuit status, and the AC adapter 1 is on. Therefore, the electronic device 17 synchronously controls on/off of the computer peripheral apparatus being connected to the AC adapter 1 subject to the on/off status of the motherboard 9 (mainframe 2) of the computer.

A prototype of AC adapter for computer has been constructed with the features of FIGS. 2˜5. The AC adapter for computer functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An AC adapter installed in the mainframe of a computer and adapted to provide the necessary working voltage to the motherboard of the computer through a PS-ON signal line, comprising a housing, an exhaust fan mounted inside said housing in front of an exhaust port in a back panel of said housing, wherein a set of electric connectors including an AC power input socket adapted to receive external AC power supply and a plurality of AC power output sockets adapted to output AC power supply from said AC power input socket to computer peripheral apparatus connected thereto, and an electronic device, which is comprised of a relay, is installed in said housing to synchronously turn on/off said AC power output sockets subject to the on/off status of a motherboard on/off control switch that controls on/off of the motherboard of the computer or the operation of an operating software program that controls the operation of the motherboard of the computer.
